(19) United States
(12) Patent Application Publication
(10) Pub. No.: US 2008/0061596 A1
(43) Pub. Date: Mar. 13, 2008

(54) Vehicle low cost braking aerostabilizer

(76) Inventors: Allan L. Brown, North Miami, FL (US); Donald E. Burg, Miami, FL (US)

Correspondence Address: Donald E. Burg, 15840 SW 84 Avenue, Miami, FL, 33157, US

(21) Appl. No.: 11/517,664

(22) Filed: Sep. 8, 2006

(51) Int. Cl. B62D 35/00

(52) U.S. Cl. 296/180.1

(57) ABSTRACT

This invention defines a low cost easily installed aerostabilizer, more commonly called a wing or spoiler, for vehicles that rises from a more horizontal than vertical orientation that it maintains at constant or accelerating speeds to a more vertical than horizontal orientation during braking of the vehicle. Power for change to the more vertical orientation is provided from either vacuum or pressure applied to a pneumatic powering device. Low cost is maintained by use of vacuum from the vehicle's engine and/or from gas pressure from the vehicle's spare tire with other sources for either vacuum or gas pressure optional. Direction of pneumatic forces is made by braking valves that preferably derive their power from the vehicle's brake system.

### BACKGROUND OF THE INVENTION

This invention relates to the field of aerostabilizers, more commonly called wings or spoilers, used on motor vehicles to enhance the vehicle's stability and, when reoriented to a more vertical orientation during braking by powered actuators, enhance the vehicle's stopping ability. When used for braking they are sometimes called braking wings or more correctly braking aerostabilizers. Braking aerostabilizers have been successfully employed on high speed race cars, expensive sport cars, and customized vehicles.

The reason that such braking aerostabilizers have not seen widespread application is simple. They are too expensive for the average user. The aerostabilizers themselves are generally affordable; however, adding an electric actuator motor and its controls, hydraulic actuator system including a hydraulic pump and controls, or other prior art braking movement powering means can easily triple the cost. This makes such braking aerostabilizers out the reach cost wise of most potential users.

The instant invention is directed at offering a braking aerostabilizer for vehicles that is simple and low cost. It does this by offering very simple and low cost pneumatic powering means to reorient the aerostabilizer from its normal more horizontal orientation to its more vertical braking orientation. Means to accomplish this can include vacuum power that is readily available from the vehicle's engine, air pressure available from the vehicle's spare tire and/or a small low cost air pump, and/or other low cost pneumatic powering means. Control of pneumatic forces used to move the aerostabilizer during braking is preferably accomplished using low cost electric valves that are actuated by electrical energy from the vehicle's brake light system.

### SUMMARY OF THE INVENTION

A principal object of the invention is to provide a low cost braking aerostabilizer for a vehicle.

A related object of the invention is that said low cost braking aerostabilizer be actuated by pneumatic forces.

Still another object of the invention is that it include a pneumatic cylinder and wherein when brakes of the vehicle are energized pressure forces for movement of the pneumatic cylinder's piston is provided to the pneumatic cylinder through a braking valve.

A directly related object of the invention is that said braking valve is energized when brakes of the vehicle are applied.

Another directly related object of the invention is that the energy for actuation of the braking valve is supplied by the brake system of the vehicle when the brakes are applied.

A further object of the invention is that pneumatic forces for movement of the braking aerostabilizer from a more horizontal than vertical orientation to a more vertical than vertical or braking orientation be, at least partially, supplied by vacuum from the vehicle's drive engine.

A related object of the invention is that the vacuum from the vehicle's drive engine may be supplied through connector applied to the vehicle drive engine vacuum source.

A further related object of the invention is that the connector connects to a tube in pneumatic communication with the braking valve.

Another related object of the invention is that it further comprise a vacuum accumulator tank disposed in pneumatic communication with and between the drive engine and the braking valve.

An optional object of the invention is that it may include a powered vacuum pump that provides at least part of the lower than atmospheric pressure vacuum.

Another object of the invention is that it may include a vacuum gas tank to provide at least part of the lower than atmospheric pressure vacuum.

A related object of the invention is that a powered vacuum pump may be used to provide vacuum pressure to the vacuum gas tank.

Still a further object of the invention is that it may include mechanical means to adjust an angle of attack of the braking aerostabilizer when said braking aerostabilizer is in its non-braking orientation.

A directly related object of the invention is that the mechanical means to adjust an angle of attack of the braking aerostabilizer may include a set screw or similar mechanical device.

Another object of the invention is that force for actuation of the aerostabilizer may be provided by a positive pressure.

A directly related object of the invention is that such a positive pressure may be supplied from the vehicle's spare tire.

A further related object of the invention is that there be a pressure regulator between the spare tire and the aerostabilizer's pneumatic cylinder.

Yet another object of the invention is that pressurized gas for movement of the aerostabilizer is supplied through a braking valve and wherein said braking valve is energized when brakes of the vehicle are applied.

Another directly related object of the invention is that takeoff of pressure from the vehicle's spare tire is from the valve stem on such a spare tire that is in pneumatic communication with the braking valve.

A further object of the invention is that it further comprise a pressure accumulator tank disposed in pneumatic communication with and between the spare tire of the vehicle and the braking valve.

Yet another object of the invention is that it may include a powered gas pressure pump to provide pressurized gas to the spare tire.

Another object of the invention is that a pressurized gas tank may provide at least part of the pressurized gas needed for movement of the braking aerostabilizer.

A directly related object of the invention is that a powered gas pressure pump may be incorporated to provide pressurized gas to the pressurized gas tank.

### BRIEF DESCRIPTION OF THE DRAWINGS

FIG. 1 shows a typical vehicle with the instant invention low cost braking aerostabilizer installed. In this example the aerostabilizer is in its more horizontal non-braking orientation.

FIG. 2 is an illustration showing the same vehicle but with the braking aerostabilizer in its more vertical braking orientation.

FIG. 3 shows the aerostabilizer assembly only in its more horizontal non-braking orientation.

FIG. 4 is an illustration showing the aerostabilizer assembly only in its more vertical braking orientation.

FIG. 5 is a cross-section, as taken through plane 5-5 of FIG. 3, that shows the aerostabilizer in its horizontal non-braking orientation. FIG. 5 also shows a preferred embodiment means to power movement of the aerostabilizer. In this case vacuum from the vehicle's engine would be supplied to one side of a pneumatic cylinder to accomplish movement of the cylinder's piston. The condition where vacuum has been applied is shown in FIG. 6.

FIG. 6 presents a cross-section, as taken through plane 6-6 of FIG. 4, showing the aerostabilizer in its more vertical braking orientation. A vacuum that has been applied to the upper portion of the pneumatic cylinder here has resulted movement of the aerostabilizer to its braking orientation. Means than a cylinder, including a rectangular shape, or other are considered within the spirit and scope of the invention.

FIG. 7 shows and optional accumulator tank that would be used to accumulate vacuum pressure between the vehicle's engine and the braking aerostabilizer. The purpose of the accumulator tank is to speed up movement of the aerostabilizer.

FIG. 8 is a cross-section, as taken through plane 8-8 of FIG. 3, illustrates another embodiment where gas pressure for movement of a pneumatic cylinder is provided by the vehicle's spare tire.

FIG. 9 gives a cross-section, as taken though plane 9-9 of FIG. 4, that shows the aerostabilizer in its more vertical braking orientation. In this case, power for movement is provided by pressurized gas supplied to the pneumatic cylinder through the braking valve.

FIG. 10 shows an addition of an optional air pressure pump to maintain pressure in the spare tire that was presented in FIG. 8. The air pressure pump would normally have a pressure regulator associated with it.

FIG. 11 shows another way of supplying gas pressure which in this case is an accumulator tank rather than the spare tire. Note that use of the spare tire is preferred since that approach avoids the cost of and space required by the accumulator tank.

FIG. 12 presents the addition of gas pumping means which preferably includes both gas pump and pressure regulator means to supply pressurized gas to the accumulator tank. Note that the same system can be applied for use with the vacuum system of FIGS. 5 and 6 but in that case the gas pumping means is a vacuum pump system.

### DETAILED DESCRIPTION

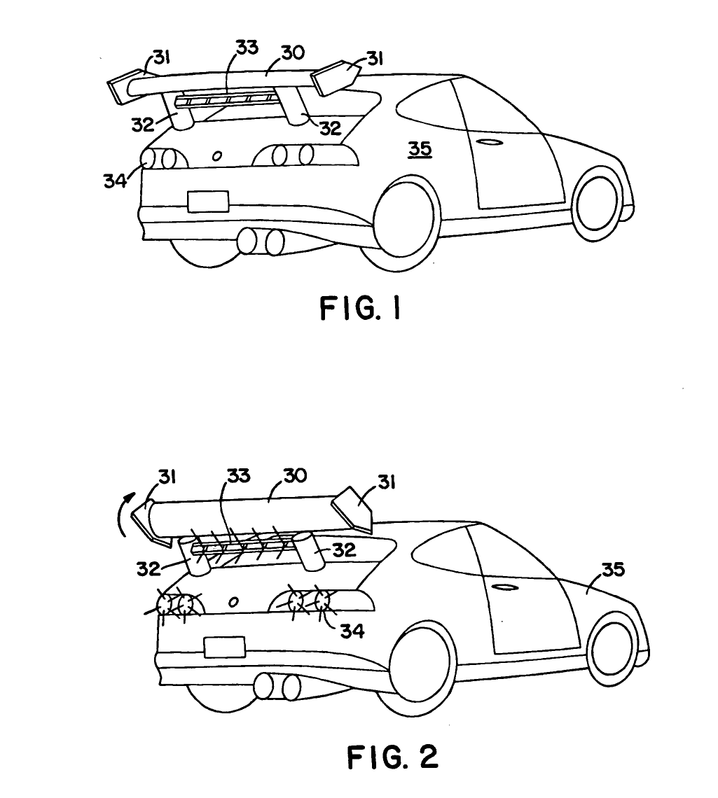

FIG. 1 presents a typical vehicle 35 with the instant invention low cost braking aerostabilizer 30 installed. In this example the aerostabilizer 30 is in its more horizontal non-braking position. Items shown in this preferred embodiment of the invention include: vehicle brake lights 34, aerostabilizer support stanchions 32, aerostabilizer end caps 31, and aerostabilizer brake lights 33. Note that more current cosmetic design thinking is to avoid the stanchions 32 and have the pneumatic cylinder internal to the aerostabilizer 30 itself or internal to a part of the vehicle 35 such as the vehicle's trunk.

FIG. 2 is an illustration showing the same vehicle 35 but with the braking aerostabilizer 30 in its more vertical braking orientation.

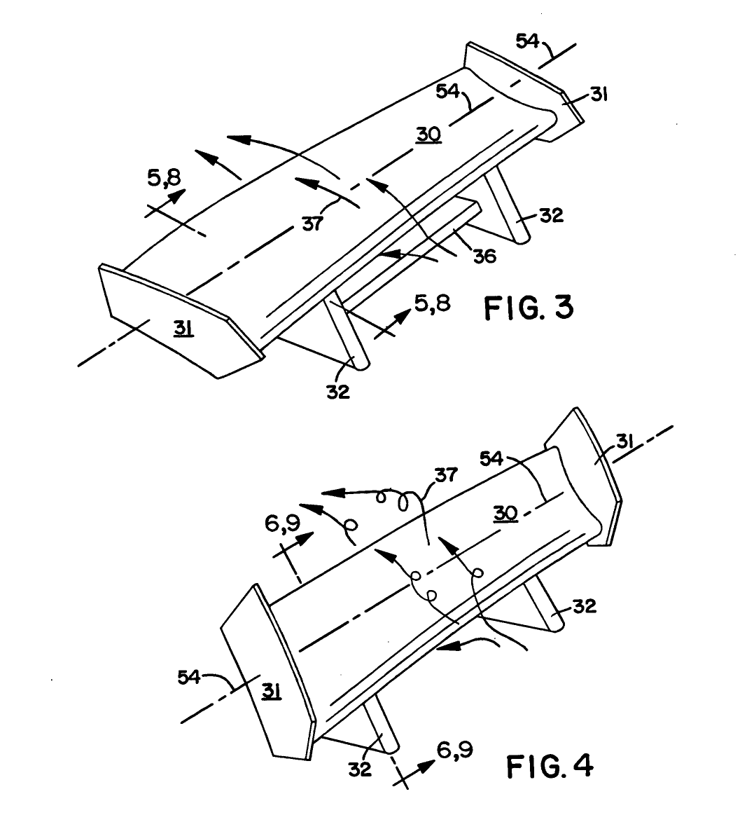

FIG. 3 shows the aerostabilizer 30 independent of a vehicle. It is in its more horizontal non-braking orientation here. The rotational axis 54 of the aerostabilizer 30, air flow arrows 37, and a brace 36 connecting the two support stanchions 32 are also shown.

FIG. 4 is an illustration showing the aerostabilizer 30 in its more vertical braking orientation.

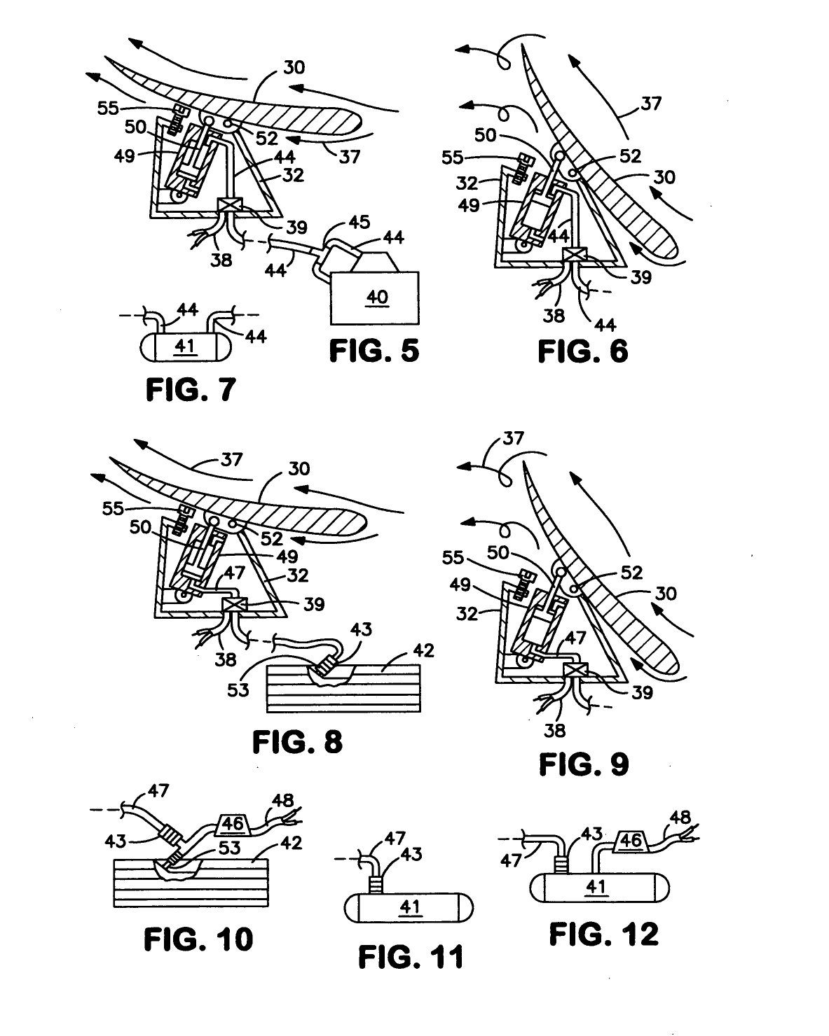

FIG. 5 is a cross-section, as taken through plane 5-5 of FIG. 3, that shows the aerostabilizer 30 in its horizontal non-braking orientation. FIG. 5 also shows a preferred embodiment means of powering movement of the aerostabilizer 30. In this embodiment the vehicle's engine 40 provides a vacuum, by way of connector means such as a Tee 45 and vacuum tubing 44, to one side of a pneumatic cylinder 49. The vacuum is supplied when a valve 39 is actuated when the vehicle's braking system is actuated with energy from the braking system passing through connector 38. Location of a typical pneumatic cylinder piston and rod 50 shows that the vacuum would be applied to the upper portion of the pneumatic cylinder 49 to accomplish movement of the aerostabilizer 30 in this instance. The pneumatic cylinder's piston and rod 50 and a pivoting means such as a pivot pin 52 are also shown. The aerostabilizer's axis of rotation, noted in FIGS. 3 and 4, would preferably pass through the pivot pin 52. A means to adjust the end stop of the aerostabilizer 30, such as set screw 55 shown here, may be incorporated to set the angle of attack of the aerostabilizer 30 when it is in its non-braking orientation.

FIG. 6 presents a cross-section, as taken through plane 6-6 of FIG. 4, showing the aerostabilizer 30 in its more vertical braking orientation. A vacuum is applied to the upper portion of the pneumatic cylinder 49 here which results in the aerostabilizer 30 moving to its more vertical braking orientation.

FIG. 7 shows an optional accumulator tank 41 that could be inserted between the engine and the brake valve to accumulate vacuum pressure between the vehicle's engine and the braking aerostabilizer. The purpose of this optional accumulator tank 41 is to decrease the response time for movement of the aerostabilizer.

FIG. 8 is a cross-section, as taken through plane 8-8 of FIG. 3, illustrates another embodiment where pressure for movement of a pneumatic cylinder 49 is provided by the vehicle's spare tire 42 by way of spare tire valve stem 53 It is important to note that virtually all components for the vacuum powered system of FIG. 5 and this pressurized system of FIG. 8 are the same except for the addition of the pressure regulator 43 here. The pressure regulator 43 drops the tire pressure to only about one pound per square inch (psi) which is sufficient to power the pneumatic cylinder 49. In such manner, the spare tire 42 is generally capable of supplying about 3,000 operations of the pneumatic cylinder 49 before it is depleted of its air supply.

Both the vacuum system presented in FIG. 5 and the pressurized air system presented in FIG. 8 are simple and low in cost and use, except for the addition of a few dollar cost pressure regulator 43 in the FIG. 8 pressurized system and the less than one dollar cost connector of FIG. 5, the same components. This is a very important concept of the instant invention where low cost is a major driving factor. A customer may employ either the vacuum or the pressurized system dependent upon which is simplest and easiest to install. In the case of the pressurized system given in FIG. 5, the user would have to repressurize the spare tire every few weeks unless a low cost air pressurization pump is added as is shown in FIG. 12.

FIG. 9 presents a cross-section, as taken though plane 9-9 of FIG. 4, that shows the aerostabilizer 30 presented in FIG. 8 in its more vertical braking orientation. In this case, power for movement is provided by gas pressure supplied to a lower port of the pneumatic cylinder 49 resulting in upward movement of the pneumatic cylinder 49.

FIG. 10 shows the addition of an optional gas pressurizing pump 46, that normally would include a pressure regulator. Such a pump would be used to set and maintain the proper pressure in the spare tire 42 that was presented in FIG. 8. A power line 48 for supplying energy to the gas pressurizing pump 46 is also shown.

FIG. 11 shows another way of supplying gas pressure which in this case is an accumulator tank 41 rather than a spare tire.

FIG. 12 presents the addition of gas energizing means, such as the gas pressurizing pump 46 that supplies pressurized gas to the accumulator tank 41. Note that the same basic concept can be applied for use with the vacuum system of FIG. 5 but in that case the gas pumping means is a vacuum pump.

While the invention has been described in connection with a preferred and several alternative embodiments, it will be understood that there is no intention to thereby limit the invention. On the contrary, there is intended to be covered all alternatives, modifications and equivalents as may be included within the spirit and scope of the invention as defined by the appended claims, which are the sole definition of the invention.

1. In an improved braking aerostabilizer for a vehicle, the improvement comprising:
a pneumatic device including a moveable piston in mechanical communication with the braking aerostabilizer for raising the aerostabilizer from a more horizontal than vertical orientation to a more vertical than horizontal orientation when brakes of the vehicle are energized wherein a pressure force for movement of the piston is provided by a lower than atmospheric pressure vacuum one side of the moveable piston and internal to the pneumatic device where the vacuum is supplied to the pneumatic device in mechanical communication with the braking aerostabilizer through a braking valve and wherein said braking valve is energized when brakes of the vehicle are applied and wherein a drive engine of the vehicle vacuum source provides at least Part of the lower than atmospheric pressure vacuum.

2. The improved braking aerostabilizer of claim 1 wherein said braking valve is electro-mechanical with its electrical function provided by an electrical signal when the brakes of the vehicle are energized.

3. The improved braking aerostabilizer of claim 1 wherein a connector means applied to the vacuum source of the drive engine of the vehicle is in mechanical communication with a tube in pneumatic communication with the pneumatic device in mechanical communication with the braking aerostabilizer.

4. The improved braking aerostabilizer of claim 1 which further comprises a vacuum accumulator tank disposed in pneumatic communication with and between the drive engine and the pneumatic device in mechanical communication with the braking aerostabilizer.

5. The improved braking aerostabilizer of claim 1 wherein a powered vacuum pump provides at least part of the lower than atmospheric pressure vacuum.

6. The improved braking aerostabilizer of claim 1 wherein a vacuum pressure gas tank provides at least part of the lower than atmospheric pressure vacuum.

7. The improved braking aerostabilizer of claim 6 wherein a powered vacuum pump provides lower than atmospheric pressure vacuum to the vacuum pressure gas tank.

8. The improved braking aerostabilizer of claim 1 which further comprises mechanical means to adjust an angle of attack of the braking aerostabilizer when said braking aerostabilizer is in its non-braking orientation.

9. In an improved braking aerostabilizer for a vehicle, the improvement comprising:
a pneumatic device including a moveable piston in mechanical communication with the braking aerostabilizer for raising the aerostabilizer from a more horizontal than vertical orientation to a more vertical than horizontal orientation when brakes of the vehicle are energized wherein a pressure force for movement of the piston is provided by pressurized gas on one side of the piston and internal to the pneumatic device where the pressurized gas is supplied to the pneumatic device through a braking valve and wherein said braking valve is energized when brakes of the vehicle are applied and wherein a spare tire of the vehicle provides at least part of the pressurized gas.

10. The improved braking aerostabilizer of claim 9 which further comprises mechanical means to adjust an angle of attack of the braking aerostabilizer when said braking aerostabilizer is in its non-braking orientation.

11. The improved braking aerostabilizer of claim 9 wherein a fitting attached to a valve stem of the spare tire of the vehicle connects to a tube in pneumatic communication with the braking valve.

12. The improved braking aerostabilizer of claim 9 which further comprises a pressure accumulator tank disposed in pneumatic communication with and between the spare tire of the vehicle and the braking valve.

13. The improved braking aerostabilizer of claim 9 wherein a powered gas pressure pump provides pressurized gas to the spare tire.

14. The improved braking aerostabilizer of claim 9 which further comprises mechanical means to adjust an angle of attack of the braking aerostabilizer when said braking aerostabilizer is in its non-braking orientation.

15. The improved braking aerostabilizer of claim 9 wherein a pressurized gas tank provides at least part of the pressurized gas.

16. The improved braking aerostabilizer of claim 15 wherein a powered gas pressure pump provides pressurized gas to the pressurized gas tank.

17. In an improved braking aerostabilizer for a vehicle, the improvement comprising:
force for movement of the braking aerostabilizer from a more horizontal than vertical orientation to a more vertical than horizontal orientation during braking supplied, at least in part, by pneumatic means including lower than atmospheric pressure vacuum from a drive engine of the vehicle vacuum source with said vacuum pressure operating a pneumatic device in mechanical communication with the braking aerostabilizer through a braking valve and wherein said braking valve is energized when brakes of the vehicle are applied and wherein said braking valve is electro-mechanical with its electrical function provided by an electrical signal when the brakes of the vehicle are energized.

18. The improved aerostabilizer of claim 17 which further comprises mechanical means to adjust an angle of attack of the braking aerostabilizer when said braking aerostabilizer is in its non-braking orientation.

19. The improved braking aerostabilizer of claim 17 wherein a connector means applied to the drive engine of the vehicle vacuum source is in mechanical communication with a tube in pneumatic communication with the braking valve.

20. The improved braking aerostabilizer of claim 19 which further comprises a vacuum accumulator tank disposed in pneumatic communication with and between the drive engine and the braking valve.
